(19) United States
(12) Patent Application Publication
(10) Pub. No.: US 2010/0005975 A1
(43) Pub. Date: Jan. 14, 2010

(54) Multi-level cavitied bun molds

(76) Inventor: Peter Bulkeley Mitchell, Silver Bay, NY (US)

Correspondence Address: PETER B. MITCHELL, P.O. BOX 2535, SILVER BAY, NY, 12874, US

(21) Appl. No.: 12/217,871

(22) Filed: Jul. 9, 2008

(51) Int. Cl. A47J 37/06

(52) U.S. Cl. 99/382; 99/439

(57) ABSTRACT

A mold for forming sandwich rolls, buns and the like which creates a contoured, multi-level cavitied interior for improved sandwich construction. Said mold having a first level cavity to compatibly receive an anticipated primary sandwich component (e.g. hamburger patty or other entree), under which is a plurality of second level cavities designed to systematically receive all or most of the anticipated secondary sandwich components, including some of the potentially messier ingredients like sauces, condiments, cheeses and veggie toppings. Furthermore, said molds adaptable for simple baking sheet application as well as high-speed automated bakery production lines for reducing baking raw material, time and costs.

### FIELD OF THE INVENTION

This invention relates broadly to utensils for food preparation, and more particularly, to molds used in forming buns, rolls and bread suitable for use in sandwiches and the like. Specifically, this invention relates to molds that create superior, contoured sandwich platforms.

### BACKGROUND OF THE INVENTION

Sandwiches, whether homemade or from a commercial restaurant, have traditionally been made on various types of sliced bread, buns and rolls. These sliced, flat platforms are problematic, particularly for the ever-increasing popularity and usage of toppings, condiments and fixings, which frequently can be messy due to one or more of the following factors:
High water content/slippery (e.g. sliced tomatoes, sliced pickles, chopped peppers, onions etc.)
Low viscosity/runny (e.g. ketchup, oil & vinegar, salsa, barbeque sauce, salad dressings etc.)
Dry particulates/crumbly (e.g. bacon bits, nuts, raisins, grated cheese, dehydrated veggies etc.)
Low adhesion/stick (e.g. shredded lettuce, shredded carrots, shredded cheese etc.)

As various combinations of these secondary sandwich components are added, they tend to form a slippery slurry that eventually oozes, drips or drops once the sandwich is compressed during normal handling, finger gripping and consumption.

There is considerable prior art that is focused on the seemingly elusive goal of creating an improved sandwich bun that effectively minimizes spillage or leakage of its contents during consumption. Towards this end, virtually all prior art is consistently focused on creating a central cavity in which to hold the sandwich ingredients. Demonstrating a myriad of techniques, prior art can be fundamentally categorized into 3 different groups. The first group of prior art teaches various methods of establishing a totally enclosed sandwich barrier around a central cavity containing the sandwich ingredients. Some examples of this “totally enclosed” approach are U.S. Pat. No. 6,874,409, U.S. Pat. No. 6,004,596 and U.S. Pat. No. 5,622,742, The second group of prior art each show novel means of creating a nearly enclosed whole bun with only limited access to a central cavity via some form of small aperture or narrow slit. This second “nearly enclosed” group includes U.S. Pat. No. 5,983,784, U.S. Pat. No. 5,528,981 and U.S. Pat. No. 5,359,925, And lastly, the third prior art group, which includes U.S. Pat. No. 5,690,019, U.S. Pat. No. 4,065,581 and U.S. Pat. No. 4,009,859, reflects either whole or partial buns with significantly more access to a well-defined cavity.

In addition to this extensive body of prior art that teach the importance of the central cavity, there are several real-market examples of this same theory. For many years, pita bread, with its hollow center, has been used as a pocket in which to stuff miscellaneous sandwich ingredients. Indeed, a few hero (a.k.a. sub, hoagie, grinder etc.) sandwich shops have been known to manually cut a v-groove in the inside surfaces of a sliced roll to create a cavity before building the sandwich.

Unfortunately, both prior art and real-market sandwiches that feature a central cavity or depression are inherently flawed in that they fail to anticipate the consequences of co-mingling all or most of the sandwich ingredients in one main cavity under typical compression during handling and consumption. Specifically, once the cavity has been filled with both the primary and secondary ingredients, as the cavity walls compress under normal finger gripping and biting pressure against the larger more solid components, the slurry mix is merely pressured towards the sandwich's nearest exit portal. Referring to the “totally enclosed” prior art group, the exit is simply the first bite entry or breach in the sandwich's perimeter wall, as many consumers can readily attest. Providing a larger cavity does not solve the problem. In fact, a larger cavity only destabilizes the sandwich by allowing the primary sandwich ingredient to shift laterally, again exerting pressure against the slurry mix towards a convenient exit.

Beyond this, much prior art reflects some structural weaknesses. As in the pita pocket sandwich mentioned above, prior art that results in a sandwich exterior wall that is either too thin, too soft or too toasted, can be self-defeating by breaking or degrading prematurely only to spill ingredients. The importance of having a complete and structurally sound perimeter rim around a sandwich's cavity cannot be understated. As evidenced by U.S. Pat. No. 5,528,981, U.S. Pat. No. 3,326,119 and others, having an open-ended cavity only allows the ingredient slurry to travel from the pressured area towards one or both of the open ends. In U.S. Pat. No. 2,556,892, Young teaches the benefits of having an “upstanding rim”, but then calls for “grids having . . . opposed spaced bosses” immediately adjacent to the perimeter rim, which causes inherent rim weakness at its base, particularly at the critical point when the cavity is fully loaded with typical sandwich ingredients.

The basic premise of the invention presented here is that, in order for a sandwich to effectively minimize spillage and/or leakage, the mold and its derivative bun must accomplish two important steps.
First, the bun must keep the secondary sandwich components adjacent to but separate from the primary sandwich ingredient. This can be accomplished by a mold that creates two distinct cavity levels, one compatibly-sized cavity for the primary sandwich component on the first level, below which will be a second level plurality of evenly distributed minor cavities to receive the secondary sandwich components.
Second, the bun must achieve structural integrity, not just of the perimeter rim, but interior integrity as well in order to prevent any significant compression that would collapse the second level plurality of cavities toward the first level major cavity. For this reason, it is important to have sufficient bun mass between second level minor cavities not only to help support the primary sandwich component (e.g. burger) but also to help maintain the structural integrity of the second level cavities under reasonable finger gripping and biting pressure.

Regarding prior art attempts to control more liquid-type ingredients, one patent warrants specific mention. Specifically, in U.S. Pat. No.3,908,022, Selleck teaches “the channel is formed with at least one transverse rib”, which indeed would prevent some lateral flow of liquids. However, Selleck fails to anticipate the need to adequately keep the solid and liquid foods separate, which compressive force would surely co-mingle.

And finally, some observations are warranted regarding the degree of accessibility of the cavity in prior art. This is an important consideration since cavity accessibility determines the variable success of condiment distribution within the sandwich. The “totally enclosed” approach (i.e. Group 1), by definition, have an inaccessible cavity that prevents any customization of condiments. The “nearly enclosed” approach (i.e. Group 2), clearly allows only very limited cavity access, which makes application of condiments difficult and likely poorly distributed. Only the third group of prior art allows adequate cavity access for proper application of secondary sandwich components.

### OBJECTS AND SUMMARY OF THE INVENTION

Accordingly, the intent of this invention is to engineer a better sandwich platform and corresponding mold with the following objects:
1. To design substantially open-faced buns, rather than “totally enclosed” or “nearly enclosed” buns, in order to allow reasonable interior access for effective distribution of desired condiment ingredients.
2. To shape the sandwich's interior with two distinct cavity levels, rather than the single cavity in prior art:
   The first level having a major cavity compatibly shaped to the profile of the anticipated primary sandwich component.
   The second level having a plurality of evenly distributed minor cavities to accommodate the size and volume of anticipated secondary sandwich components.
3. To provide a contoured sandwich platform that judiciously reduces interior mass, thereby accomplishing several objects:
   Reduced bun mass requires less sandwich-forming compound (e.g. flour, etc.) and therefore lower raw material costs.
   Reduced bun mass means proportionately less baking time and therefore lower production costs.
   Reduced bun mass dramatically reduces the overall net height of the completed sandwich by positioning more of the sandwich components within the bun, thus making the sandwich more bite-manageable and less jaw-challenging.
4. To design a more structurally sound sandwich bun:
That has a continuous perimeter rim of sufficient strength to both inhibit any lateral movement of the primary sandwich component as well as prevent any premature degradation during handling and consumption.
   That has sufficient bun mass and texture between the second level plurality of minor cavities to both properly support the primary sandwich component as well as limit any reasonable compressive force on the second level cavities during handling and consumption.
5. To create a more favorable balance of bun textures between soft and toasty:
   With a toastier/crustier texture to the bun's interior contoured surface that would improve taste and help reduce liquid absorption and resulting bun sogginess.
   While maintaining a sufficiently soft interior mass for desirable textural differentiation.
6. To improve the overall sandwich taste experience by providing a multi-level contoured sandwich platform that can effectively accommodate more of the sandwich-enhancing condiments increasingly preferred by consumers, while dramatically reducing the normally expected spillage and mess during consumption.
7. To provide a universal core mold with wide-ranging applications, from home use to high-efficiency commercial baking operations, including:
   Adapted to a kitchen utensil for one-off manual molding of dough and/or batter products.
   Incorporated into waffle iron-type appliances for easier home or restaurant use.
   Adapted to baking sheets for higher batch production.
   Incorporated into rolling pin-type configuration for automated and continuous higher-speed conveyor production.
   And which can accommodate a broad spectrum of sandwich-forming compounds from traditional dough, to more liquid batters, etc.
8. To provide methodology and sandwich construction guidelines that will maximize the effectiveness of the unique multi-level cavitied sandwich platforms derived from this invention. Specifically, to provide condiment placement strategy based on component shape, size, water content, relative viscosity and adhesion factors:
   The larger, more solid sandwich component(s) are placed in the first level major cavity.
   The smaller, less solid secondary sandwich components are placed in the deeper level cavities.
   Of the secondary sandwich components, the smaller, the more liquid/less viscose and the less adhesion, the deeper the placement within these lower level cavities.

Further objects of this invention will become more apparent from the following description in which the preferred embodiments have been set forth in detail in conjunction with the accompanying drawings.

### BRIEF DESCRIPTION OF DRAWINGS

FIGS. 1A and 1B are perspective views of the preferred embodiment of a duplex bun base and corresponding mold, respectively, reflecting a circular hamburger cavity-producing shape on the first level and a second level plurality of radial valley cavity-producing shapes.

FIGS. 2A and 2B are top plan perspective views of the same preferred embodiment of bun and mold, respectively, as depicted in FIGS. 1A and 1B, featuring the circular hamburger and radial valley configuration.

FIGS. 3A and 3B are transverse sectional perspective views of the same preferred embodiment bun and mold, respectively, as depicted in FIGS. 1A and 1B, featuring the circular hamburger and radial valley configuration.

FIGS. 4A, 4B, 4C, 4D and 4E are simplified transverse sectional front elevation views of an open-faced sandwich, 50/50 enclosed sandwich, 25/75 enclosed sandwich, a 25/25 non-enclosed sandwich and a middle bun layer configuration, respectively.

FIG. 5 is a simplified front elevation of a triplex cavitied bun, detailing Cavity Level Schematics.

FIGS. 6A and 6B are perspective views of an alternative preferred embodiment bun and corresponding mold, respectively, that feature a similar circular hamburger cavity-producing shape in the first level, but a different second level grid of intersecting valley, cavity-producing shapes.

FIGS. 7A and 7B are perspective views of another alternative preferred embodiment bun and mold, respectively, that feature a largely square hamburger cavity-producing shape in the first level and a second level grid of intersecting valley, cavity-producing shapes.

FIGS. 8A and 8B are perspective views of a frankfurter-type alternative version of the preferred embodiment bun and mold, respectively, that feature an elongated frankfurter-type cavity-producing shape on the first level and a second level grid of intersecting valley cavity-producing shapes.

FIGS. 9A and 9B are perspective views of yet another alternative embodiment of bun and mold, respectively, in this case custom-shaped for a salmon steak-type sandwich.

FIGS. 10A and 10B are perspective views of another bun and corresponding mold, in this case representative of the most basic embodiment of the present invention, here featuring a generic circular hamburger cavity-producing shape in the first level and a second level plurality of independent, semi-spherical cavity-producing shapes, the 2-level cavity-shaping means positioned on a largely rigid sheet material.

FIG. 11 is a perspective view of an alternative version of the most basic bun mold depicted in FIG. 10B, in this case with the additional element of a perimeter containment wall.

FIG. 12 is a perspective view of yet another modification of the most basic bun mold depicted in FIG. 10B, in this case configured with a second level plurality of truncated, hexagonal pyramids as well as the additional element of a perimeter gutter surrounding this 2-level cavity-shaping means.

FIG. 13 is a perspective view of yet another modification of the most basic bun mold depicted in FIG. 10B, in this case configured with a second level plurality of truncated, hexagonal pyramids as well as the additional element of a handling means attached to the 2-level cavity shaping means.

FIG. 14 is a perspective view of yet another modification of the most basic bun mold in FIG. 10B, in this case configured with a second level plurality of truncated, polygonal pyramids as well as two additional elements, namely an opposing, compatible well mold plus an alignment means in the form of a plurality of vertical alignment rods and holes between this well mold and the second level cavity-shaping means.

FIG. 15 is a perspective view of the modified bun mold depicted in FIG. 14, in this case configured with a typical waffle-iron type hinge as an alignment means between the second level cavity shaping means and the opposing well mold.

FIGS. 16A and 16B are perspective views of yet another modification of the most basic bun and mold, respectively, depicted in FIG. 10B, configured here with the additional element of an interlocking molding means in that portion of the mold which shapes the bun's perimeter rim, in this case, castle wall-stepped for engaging two similar, opposing bun halves.

FIGS. 17A and 17B are perspective views of an alternative embodiment of the bun and mold, respectively, depicted in FIGS. 16A and B, configured here with alternating perimeter rim nubs and compatible holes for engaging two similar, opposing bun halves.

FIG. 18 is a perspective view of an alternative embodiment of the mold featured in FIG. 11, in this case the perimeter containment wall and 2-level cavity-shaping means submerged into the largely rigid sheet material, thus forming a mold well.

FIG. 19 is a perspective view of yet another alternative preferred embodiment of the present invention, namely a plurality of the mold embodiment depicted in FIG. 7B, arrayed about the surface of a cylindrically-shaped rolling pin for the purpose of molding 2-level cavitied buns in sequence.

### REFERENCE NUMERALS IN DRAWINGS

| | |
|---|---|
| 10 | bun base |
| 12 | bun lid |
| 14 | perimeter rim |
| 16 | perimeter wall |
| 18 | perimeter bottom |
| 20 | first level depression |
| 22 | second level cavity network |
| 24 | second level platforms |
| 26 | truncated octagonal pyramid |
| 27 | chair-like supports |
| 28 | radial valley |
| 30 | concentric valley |
| 32 | cavity floor |
| 34 | cavity wall |
| 36 | third level cavity network |
| 38 | hamburger patty |
| 40 | bun mold |
| 42 | rigid sheet material |
| 44 | first level cavity-shaper |
| 46 | second level cavity-shaping network |
| 48 | perpendicularly oriented walls |
| 50 | concentric walls |
| 52 | radial walls |
| 54 | wall face |
| 56 | wall top |
| 58 | outer containment wall |
| 60 | vent holes/air channels |
| 62 | rim margin |
| 64 | wall margin |
| 66 | bottom margin |
| 68 | bun middle layer |
| 70 | intersecting valleys |
| 72 | hot dog |
| 74 | salmon steak |
| 76 | ridged walls |
| 80 | semi-spherical cavity |
| 82 | semi-spherical dome |
| 90 | handle |
| 92 | perimeter gutter |
| 94 | vertical guide rods |
| 96 | guide holes or shafts |
| 98 | compatibly-shaped well |
| 100 | opposing rigid sheet material |
| 102 | hinge |
| 110 | bun rim step-up segment |
| 112 | bun rim step-down segment |
| 114 | mold rim step-up segment |
| 116 | mold rim step-down segment |
| 120 | bun nub tips |
| 122 | bun nub holes |
| 124 | mold nub tips |
| 126 | mold nub holes |
| 130 | well wall |
| 140 | rolling pin/cylindrical member |
| 142 | rolling pin axle or handle |
| 144 | rigid table top |
| 146 | arrayed square bun mold |
| 148 | pre-determined dough quantity |

Specification

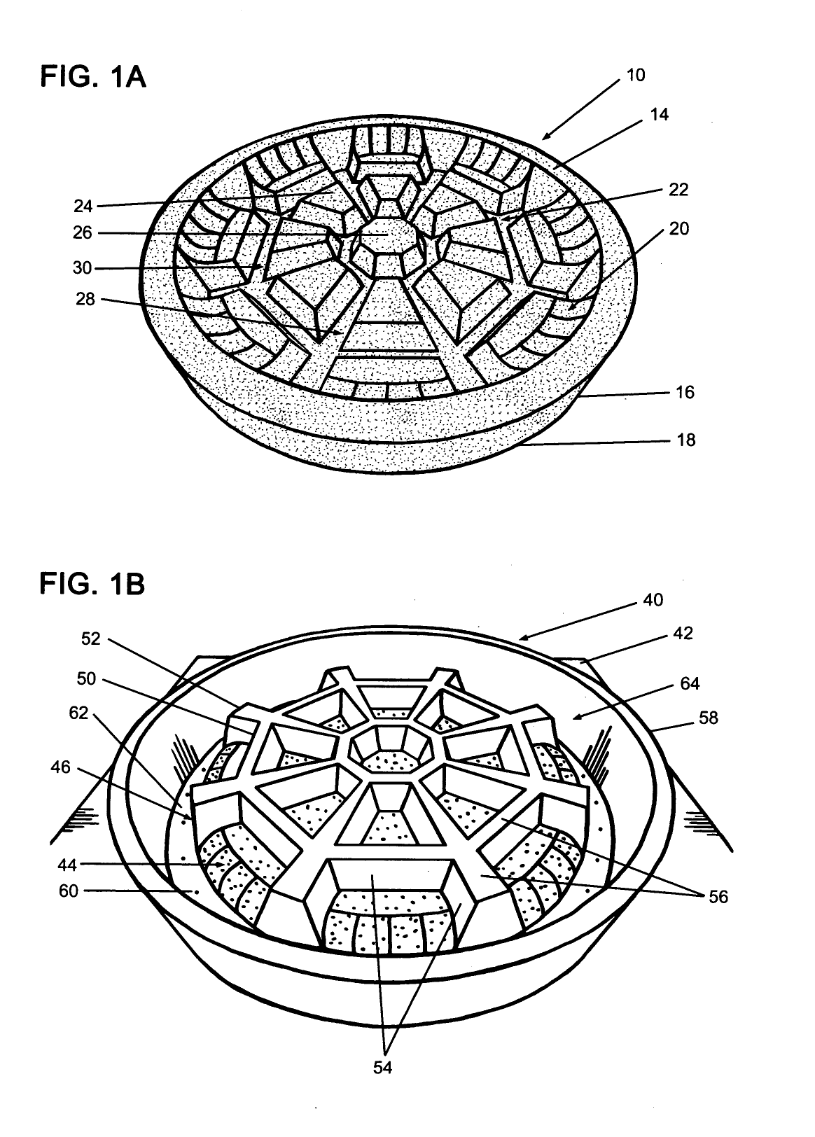

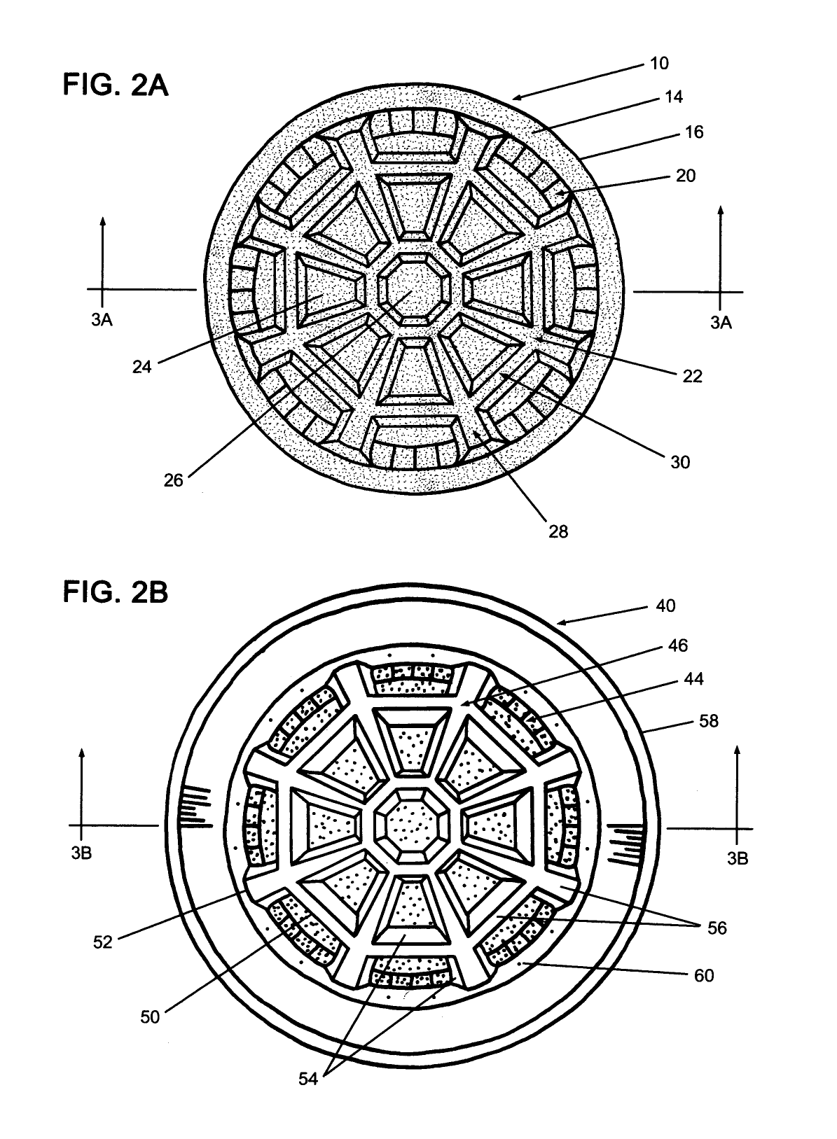

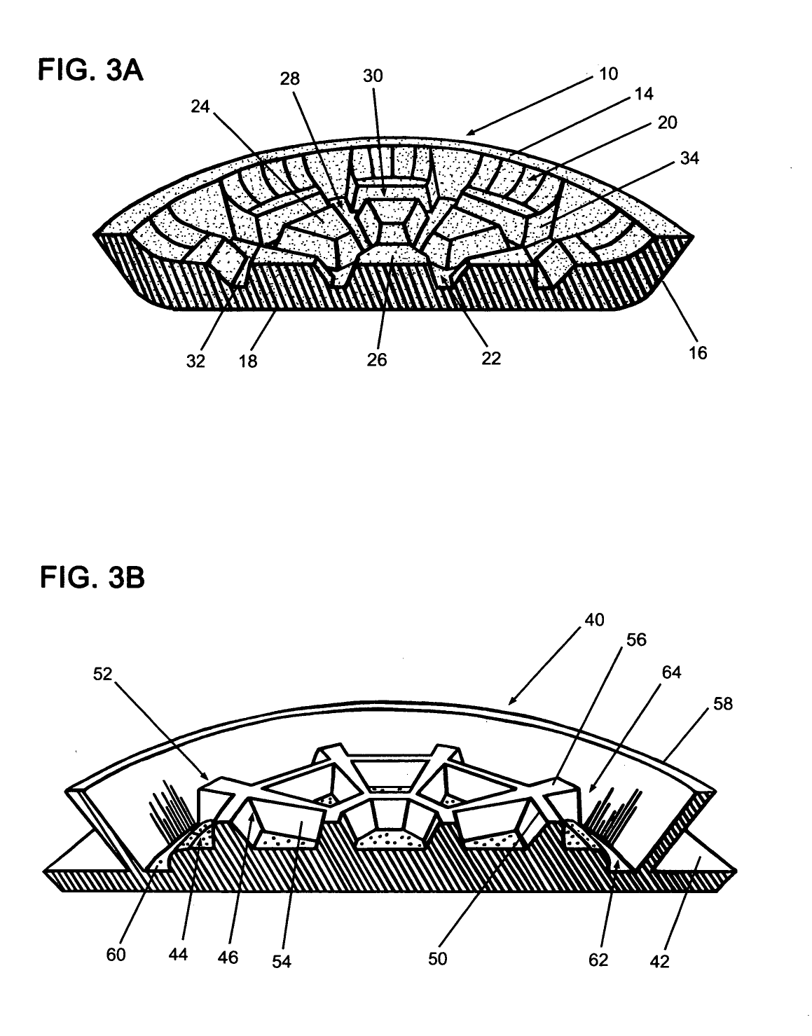

To best understand the preferred mold embodiment of this invention, an examination of both the mold and the end-resulting bun or sandwich base that results from this mold embodiment is warranted, as they are directly related, albeit opposite. Referring to FIGS. 1A, 2A and 3A, the bun base 10, or alternatively the bun lid, is largely circular with a duplex-cavitied interior. The first level depression 20 or cavity is circular and shaped to compatibly receive all or a portion of the primary sandwich component, in this case the bottom half of a circular, largely flat burger patty. Directly below this first level depression 20 is a plurality of second level cavities or second level cavity network 22, designed to compatibly receive the anticipated secondary sandwich components. In this case, network 22 consists of eight radial valleys 28 that intersect two concentric valleys 30. The remaining non-cavitied area of bun base 10 second level comprises a variety of second level platforms 24, including a truncated octagonal pyramid 26 in the center and a series of chair-like supports 27 just inside perimeter wall 16. Collectively, second level platforms 24 help support a theoretical hamburger patty (not shown). Furthermore, chair-like supports 27 help reinforce the structural integrity of perimeter wall 16.

It should be noted here that the exact shape and configuration of second level cavity network 22 is quite flexible, as will be illustrated later, providing the following criteria are achieved:
The combined volume of network 22 is greater than or equal to the anticipated volume of all or nearly all secondary sandwich components.
The collective second level cavities are broadly positioned beneath first level depression 20 for desirable maximum distribution of secondary sandwich components like condiments and toppings.
The remaining sandwich base between the second level cavities provides adequate support for the primary sandwich component positioned in the first level depression 20.

The exterior of bun base 10 is largely traditional in appearance with an uninterrupted perimeter rim 14, perimeter wall 16 and perimeter bottom 18. For the purpose of this invention, the bun's exterior shape and texture is of relative low importance. Although the exterior shape of the bun can take virtually any form including square, elongated or other unique shapes, generally speaking, the exterior bun profile will largely magnify the profile of the sandwich's anticipated ingredients, allowing for a reasonable margin of thickness for perimeter rim 14, wall 16 and bottom 18.

FIGS. 1B, 2B and 3B show similar perspectives of the correlating preferred embodiment bun mold. Bun mold 40 features a first level cavity-shaper 44, in this case a burger-shaped dome, mounted on the surface of substantially rigid sheet material base 42. Directly above this first level cavity-shaper 44 is the second level cavity-shaping network 46, formed by eight radial walls 52 that intersect two concentric walls 50. Clearly, the largely flat wall tops 56 and sloped wall faces 54 form the corresponding radial valleys 28 and concentric valleys 30 mentioned earlier in bun base 10. A largely vertical containment wall 58 arises from sheet material base 42 and surrounds this two level cavity-shaping interior. The lateral separation between the interior face of containment wall 58 and exterior face of cavity-shaper 44 and 46 defines bun rim margin 62 and bun wall margin 64. The differential in height between the top of containment wall 58 and the top of second level cavity network 46 helps determine the bun's bottom margin 66, not accounting for any rise and/or contractive factor during proofing and/or baking, as would be understood by those in the trade.

The preferred embodiment molds of this invention are designed to receive all manner of sandwich-forming compounds, with minimal variations to the mold, from traditional bread doughs to batters and even non-flour applications like fruit slurry (e.g. Fruit Roll Ups®), potato pancake or other vegetable-based batters or even ice cream and/or candied mixtures. Note that containment wall 58 is an optional element, being useful for more fluid batter-type mixes and less necessary for higher viscosity sandwich-forming compounds like dough, etc.

Bun mold 40 can be used in a variety of heat and non-heat applications. For those sandwich-forming compounds that do not require baking, like fruit slurry, these molds can be used simply for air or sun-drying (i.e. no direct heat). Similarly, these molds can be used simply as a “proofing” stand for yeast-based dough, prior to baking. Another non-heat application would involve using the mold in a press and release sequence that would form traditional dough into the desired contoured shape prior to the baking step. Another common application would involve using the mold not only for shaping the sandwich-forming compound, but also as a vessel in or on which to apply heat and bake. This vessel could be incorporated into a simple baking sheet or perhaps into a waffle-iron type appliance.

The preferred mold embodiment will be made from a substantially rigid material. In cases where heat is to be applied, sheet metal material would be the obvious low-cost choice, although ceramic and stone would be viable alternative materials. For non-heat applications of the mold, other rigid materials are viable including wood and/or plastic. If these molds are used as a cooking vessel, obviously the duration and manner of heat application will influence the bun texture. Due to the fact that the preferred embodiment molds of this invention will result in contoured sandwich buns with significantly less interior mass, baking time will be substantially reduced. Variations in baking temperature, direct versus indirect heat application and duration will determine the resulting bun surface and interior textures, in terms of softness versus toastiness, as will be readily understood by those in the trade.

Since different sandwich-forming compounds will have varying mold adhesion characteristics, several mold release strategies can be used, as well as minor variations to mold design be considered. Beyond the use of cooking oil being periodically applied to the mold, a more permanent solution would be to coat the interior surfaces of bun mold 40 with a non-stick coating means (e.g. Teflon®). Additionally, there are numerous modest structural modifications that can be made to mold 40 to reduce the adherence factor, if necessary, including the following. Reduce the slope of cavity-shaping wall faces 54. Provide more rounded transitions between wall faces 54 and wall tops 56. Reduce the height (i.e. cavity depth) of second level cavity-shaping network 46. Additionally or alternatively, the mold can be modified with a plurality of small vent holes or air channels 60 through sheet material 42 into the rim margin 62 (i.e. perimeter rim 14-producing) or other potentially adhesion-challenged areas of mold 40. This would accomplish two potential benefits. First, these air channels 60 would allow potentially trapped air in the deeper recesses of mold 40 to escape more readily as sandwich-forming compound is introduced to the mold. Vacuum pressure means could be applied to further enhance the settling of the compound into the mold's recesses. Secondly, air pressure could be applied through these air channels 60 to help dislodge or pop the finished sandwich bun (i.e. post proofing or baking) from mold 40, if deemed necessary.

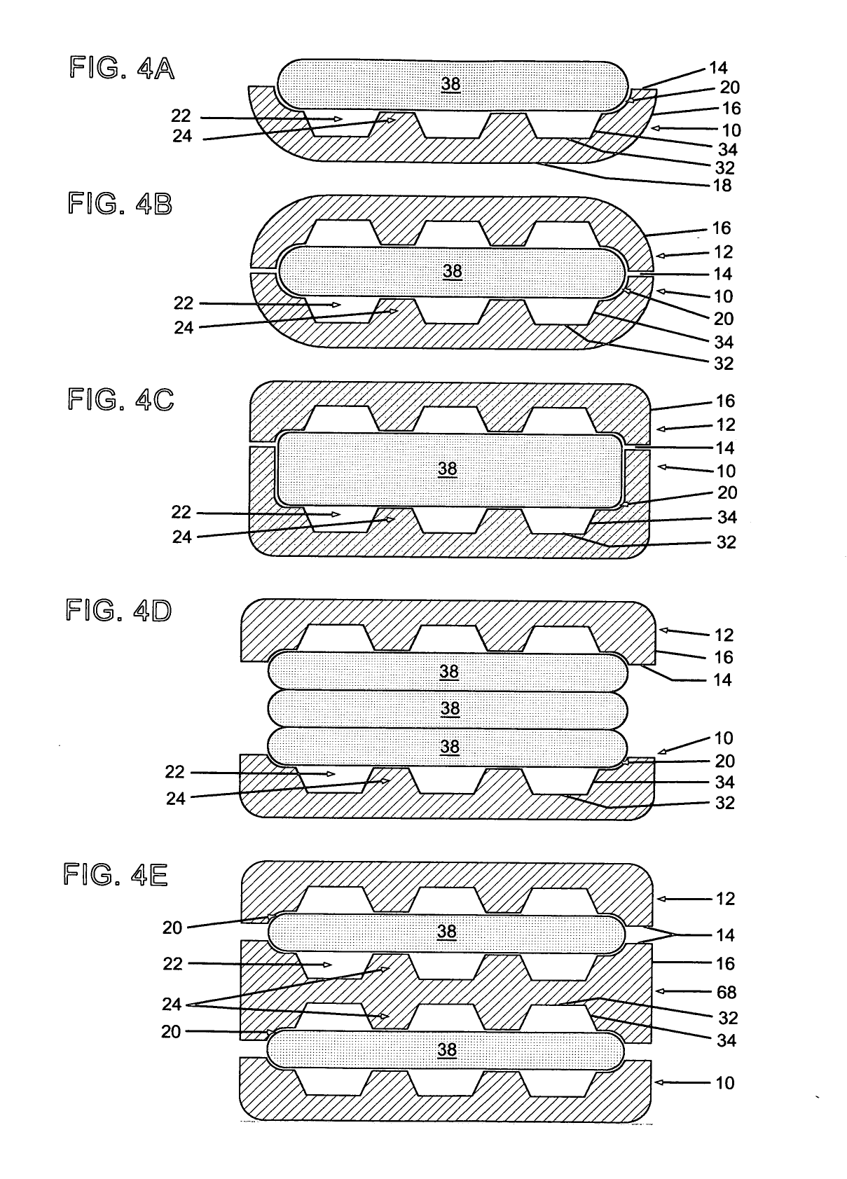

Again referring to FIGS. 1A, 2A and 3A, bun base 10 reflects a first level depression of the bottom half profile of a typical circular, flat burger patty. Clearly, the size, shape and depth of first level depression 20 is optional to accommodate all manner of primary sandwich components. A thicker burger or a stack of patties might call for a deeper depression. Conversely, depression 20 can be made more shallow to reveal more of the primary sandwich component for a variety of conceivable reasons including possible consumer aesthetic preference, bread calorie reduction or other marketing rationale. Realistically, depression 20 should be minimally approximately ⅛ inch deep so as to provide at least some lateral stability for the primary sandwich component. Note that the size and dimensions of depression 20 should be compatible with the final dimensions of the primary sandwich component, reflecting any anticipated shrinking or expansion during the preparation process. Referring to FIGS. 4A-E of simplified cross-sectional bun front elevations, FIG. 4A illustrates a bun open-faced sandwich with bun base 10's depression 20 at approximately 50% of profile height of burger patty 38. FIG. 4B shows a totally enclosed sandwich with identical bun base 10 and bun lid 12. FIG. 4C illustrates another totally enclosed sandwich, but with bun base 10 having a much deeper depression 20 to accommodate the thicker burger patty 38 and lid 12 of minimum depth. FIG. 4D shows a symmetrical bun base and lid combination, both having more shallow depressions 20 to give more lateral exposure to the triple patties 38 within. Yet another variation is illustrated in FIG. 4E, in which the sandwich has a middle bun layer with the multi-level cavitied impression on both upper and lower faces, in order to compatibly receive an additional primary sandwich component.

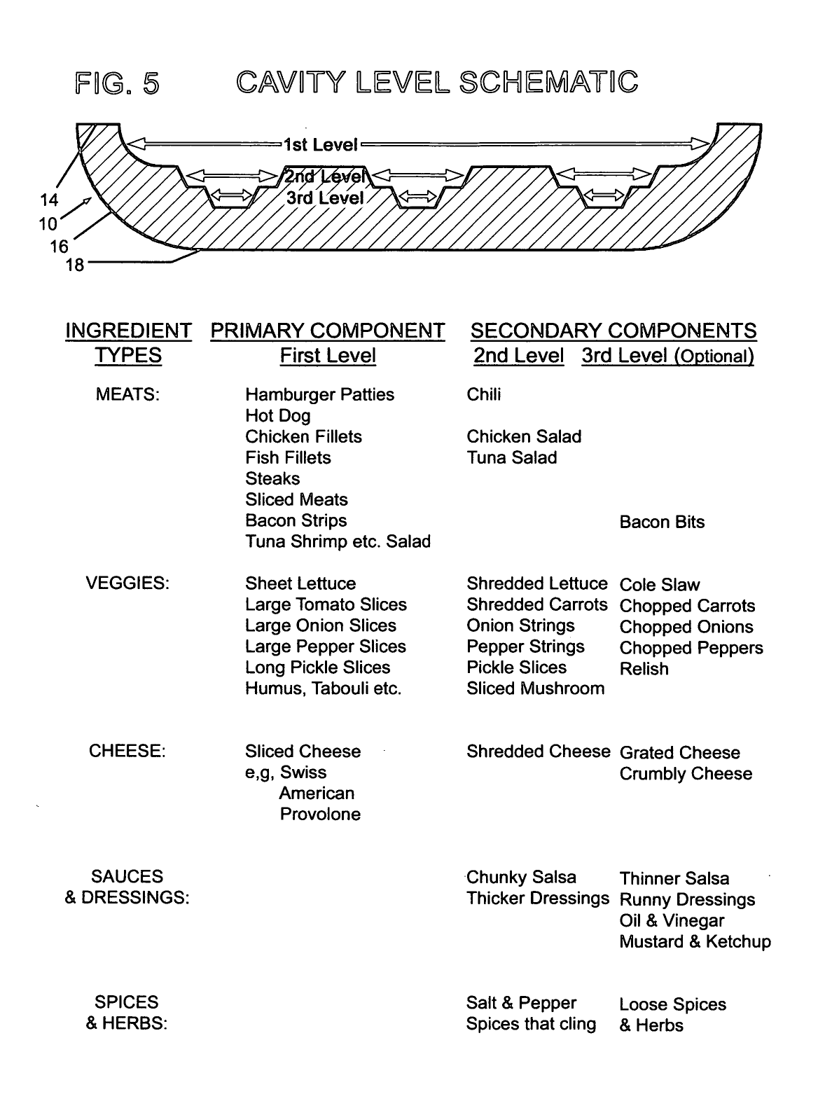

Given the unique multi-level cavity configuration of the buns derived from these preferred mold embodiments, a brief discussion of sandwich component placement theory is warranted, regarding which types of sandwich ingredients are placed in which cavity levels. Referring to FIG. 5, first level cavity 20 is designed to compatibly receive the primary sandwich component (i.e. by definition, the largest and most dominant sandwich ingredient), in this example, the circular, flat burger patty. Clearly, other types of primary sandwich components, such as hot dog, fish fillet, sliced sandwich meat etc. would have their own custom profile depressions. This is particularly advantageous for high volume fast food operations where the shape and size of their meat entrees is highly standardized and infinitely duplicatable. Note that a primary sandwich component can be a combination of items, especially if they are intertwined or of high adherence like cheeseburger (i.e. burger plus melted cheese slice), chicken parmesan, etc.

The second level and optional third level cavities are designed to compatibly receive the secondary sandwich components, which tend to be smaller, less solid and potentially more messy. Sliced pickles and tomatoes and shredded cheese, lettuce and carrots are all examples of secondary sandwich components ideally destined for second level cavity placement. Among the secondary sandwich components, the smaller, more liquid/less viscose and less adhesive, the deeper the placement within the second level cavities or into the optional third level cavities. Examples of this last category would be crumbly cheese bits, bacon bits or sauces that tend to run easily.

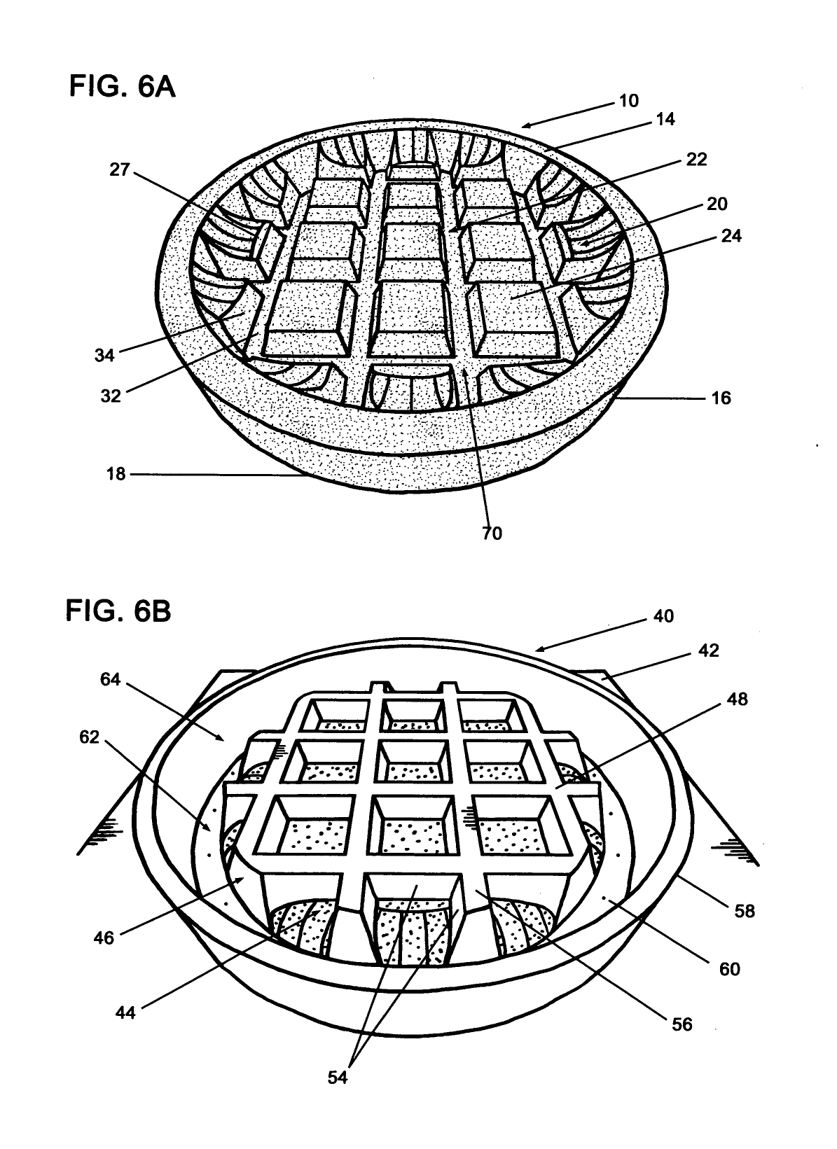

As mentioned earlier, there is an infinite range of possible shapes and configurations to a bun's second level cavities and corresponding mold's second level cavity shaping network. FIGS. 6A and B illustrate one such variation of the preferred embodiment. Bun base. 10 in FIG. 6A features a network 22 of perpendicularly intersecting valleys 70 which creates a remaining non-cavitied area consisting of truncated, square pyramid-like second level platforms 24 and a perimeter ring of chair-like supports 27. FIG. 6B shows the corresponding network 46 of perpendicularly oriented walls 48 in bun mold 40's second level.

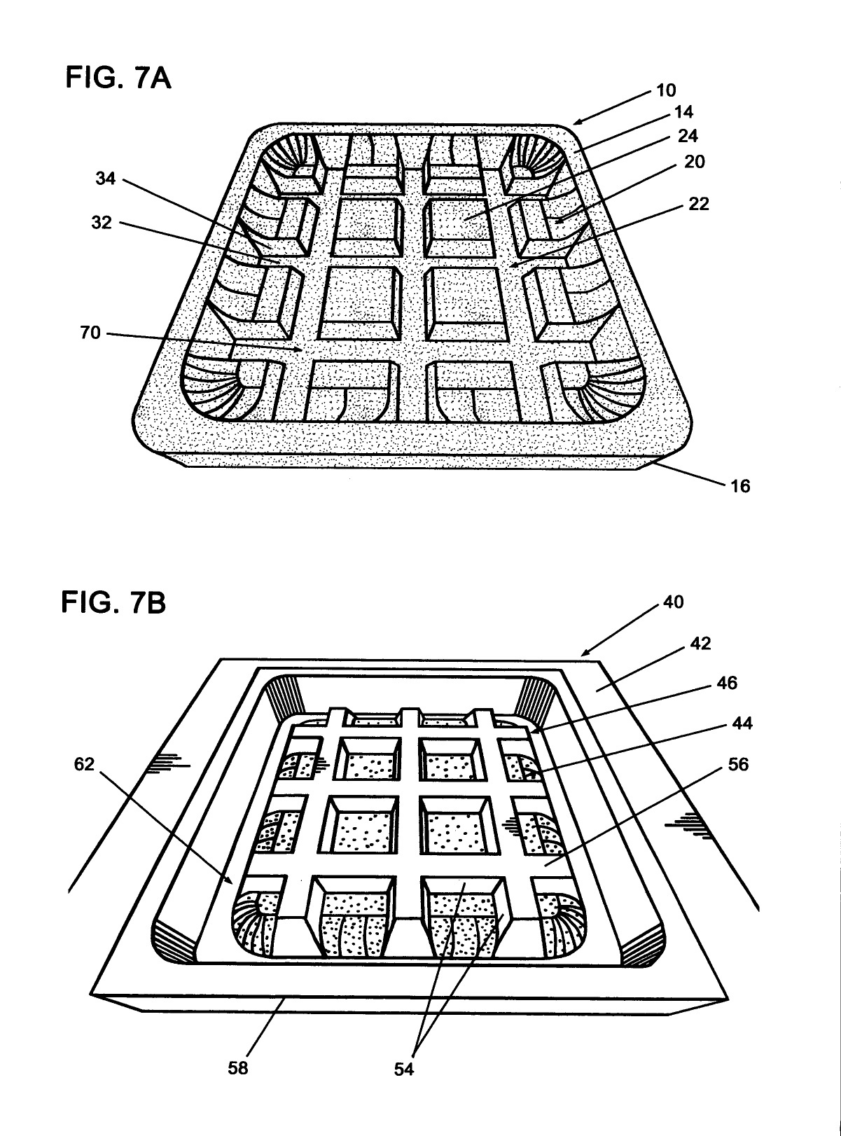

Unlike the bun/bun molds of FIGS. 1 and 6 which both have the traditional round bun shape, an alternatively square embodiment is shown in FIGS. 7A and B, reflecting a first level depression 20 and cavity-shaping network 26, respectively, that accommodate a largely square hamburger patty with flat bottom and rounded perimeter edges. This bun/bun mold features a similar perpendicular grid-type second level cavity-shaping network 46 as seen in FIG. 6B. Although the exterior shape of this bun can take any form, a square bun provides a consistent “bread” rim margin 62 and wall margin 64 around the square burger-shaped depression 20.

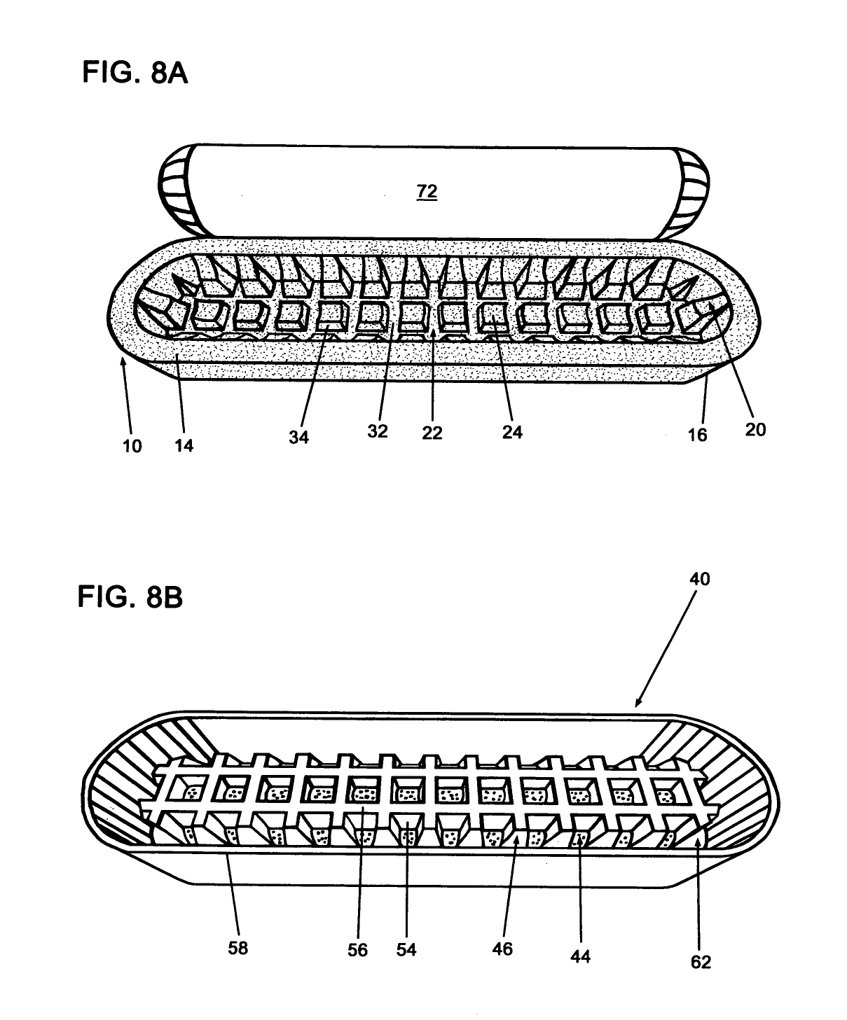

FIG. 8A illustrates a hot dog bun base 10 version of the preferred embodiment, featuring an elongated depression 20 designed to compatibly receive the bottom half of a frankfurter. Below this is the second level cavity network 22 of perpendicularly intersecting valleys 70. FIG. 8B shows the corresponding hot dog bun mold 40 featuring the cavity-shaping network 46 of perpendicular intersecting walls 48. Intersecting valleys of bun 10 will insure widespread and even distribution of secondary sandwich components.

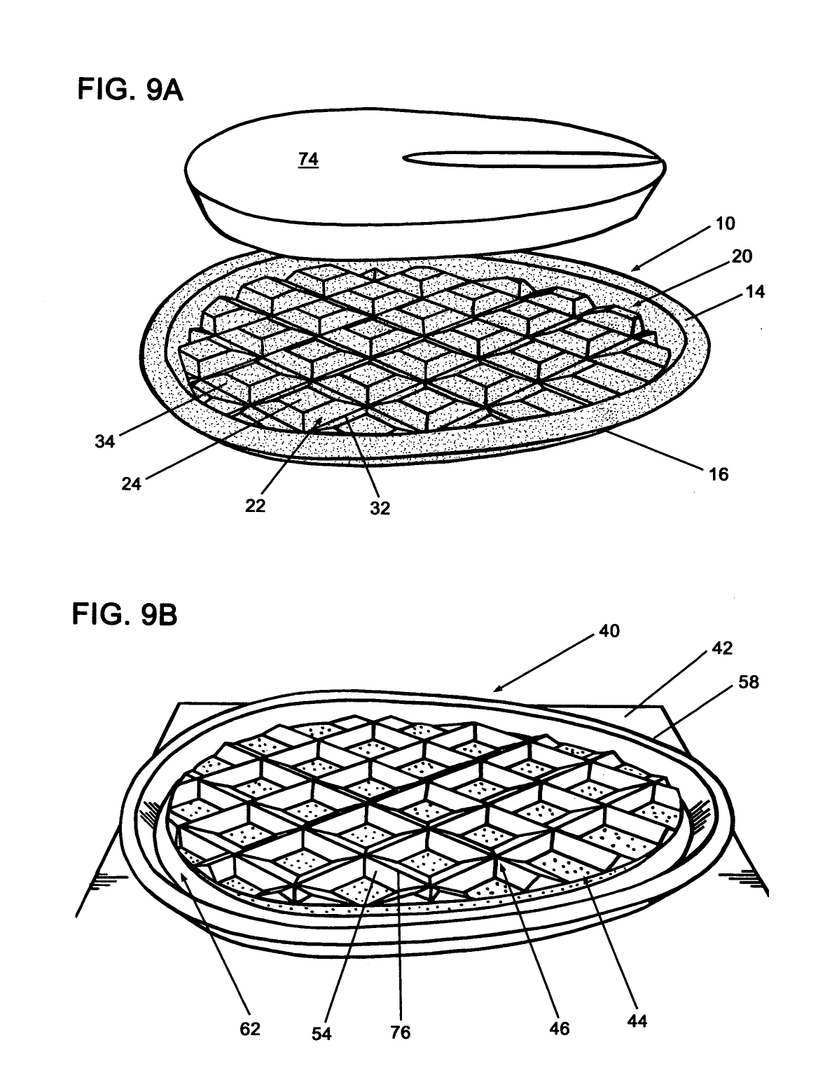

FIGS. 9A and B represent yet another example of the preferred embodiment, here illustrating a unique bun/mold designed to accommodate a salmon or similarly shaped fish steak 74. Second level cavity network 22, consisting of diagonally intersecting valleys, provide sufficient space and distribution for anticipated secondary sandwich components, while the remaining grid of second level platforms will properly support salmon steak 74. FIG. 9B illustrates bun mold 40 of opposite shape, featuring first level cavity-shaper 44, namely the bottom half profile of salmon steak 74, plus second level cavity-shaping network 46 diagonally intersecting ridged walls 76.

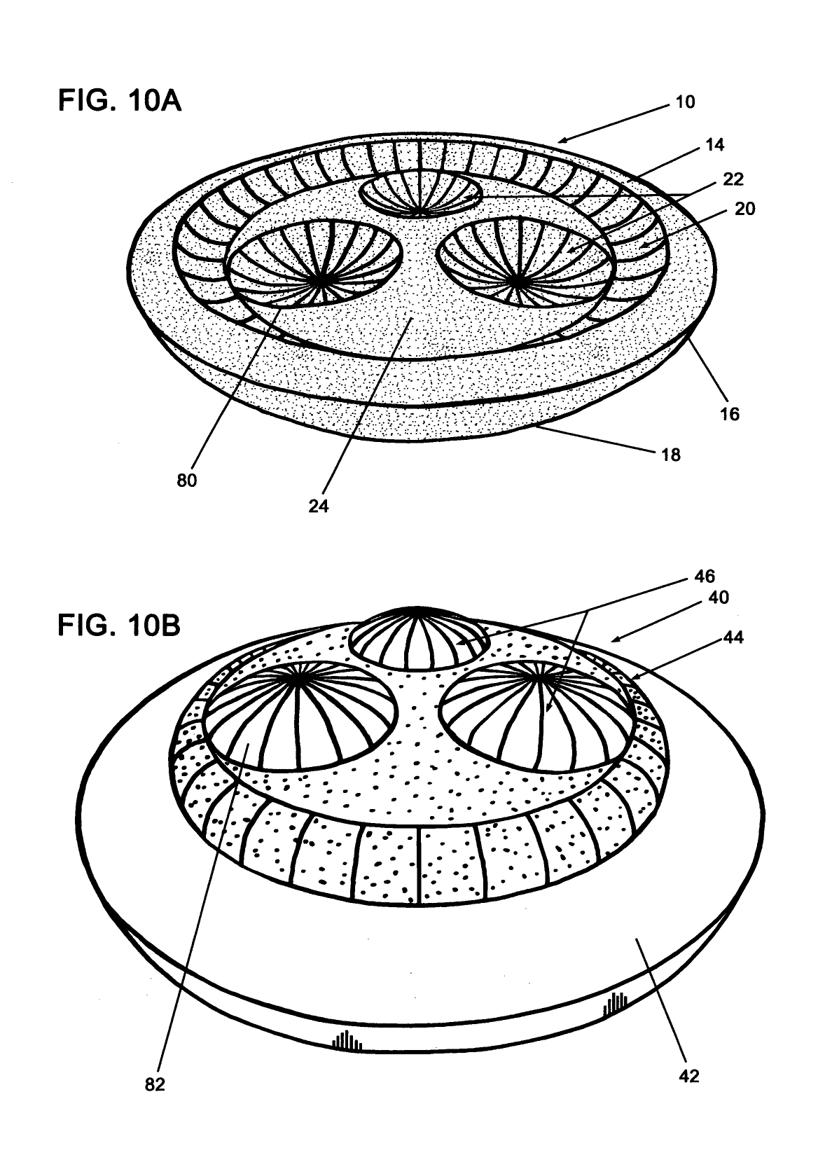

FIGS. 10A and B illustrate the most basic form of bun and corresponding mold embodiment, respectively, of this invention. FIG. 10A shows bun base 10 with a generic, circular depression 20 and a second level cavity network 22 of two or more semispherical cavities 80. Referring to FIG. 10B, note that this most basic bun mold embodiment 40, featuring a circular-shaped dome first level cavity shaper 44 along with three semi-spherical domed second level cavity-shaping network 46, does not include an outer containment wall 58 as in previously discussed embodiments. This more spartan mold assumes use of a non-batter type sandwich-forming compound. Although FIG. 10A depicts bun base 10 with a consistent width of perimeter rim 14 and wall 16, these margins are actually variable, depending on the amount or thickness of sandwich-forming compound that is applied to the exterior of most basic mold 40.

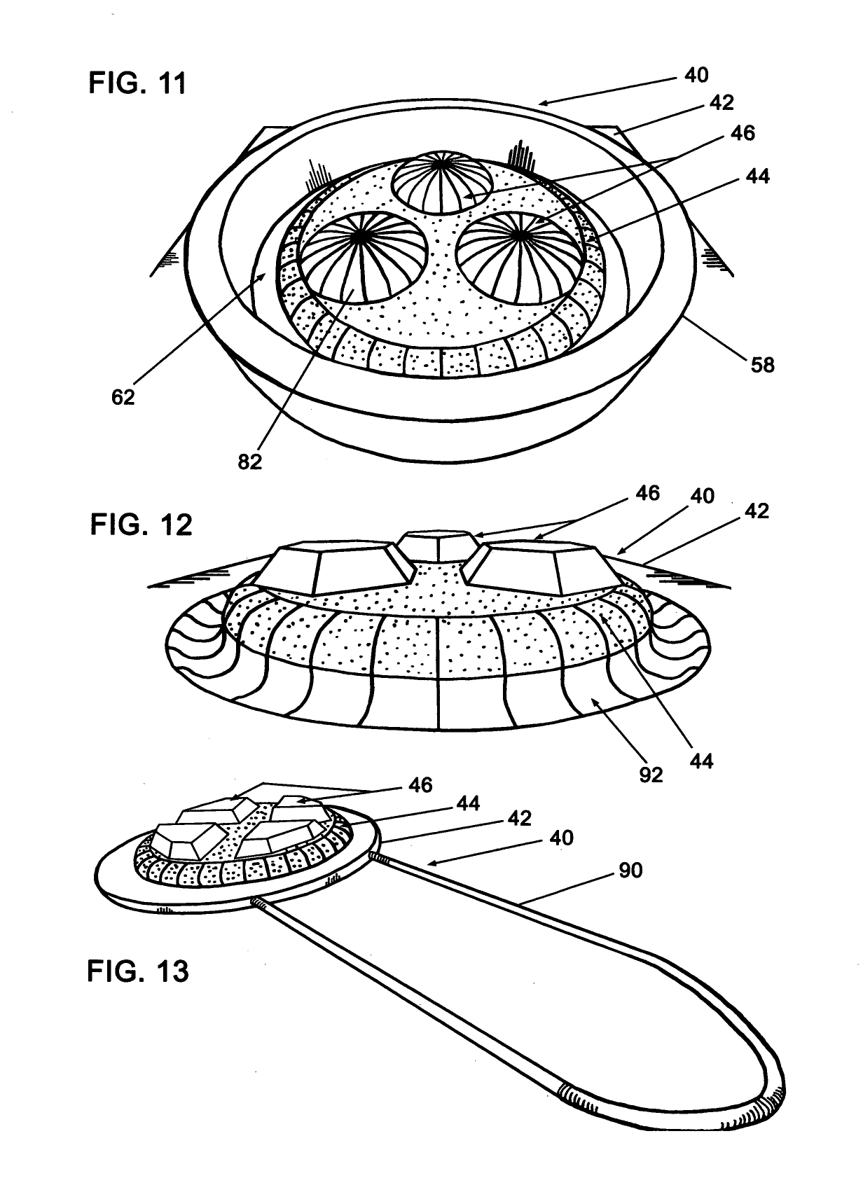

FIG. 11 depicts the same most basic mold embodiment just discussed (FIG. 10B) but with the one additional element of outer containment wall 58 on sheet material 42 to broaden usage to include less viscous/more fluid batter-type sandwich-forming compounds.

FIG. 12 illustrates an alternative version of the most basic mold embodiment shown in FIG. 10B, but in this instance including the extra element of a perimeter gutter 92 depressed into rigid material 42. This addition of gutter 92 would allow a slightly less viscous dough-like sandwich-forming compound to settle and shape itself, without resorting to a containment wall 58 (not shown).

FIG. 13 shows yet another variation on the most basic mold embodiment of FIG. 10B, here with the one additional element of wire handle 90 attached horizontally to rigid material 42. The purpose of this handle is to enhance controlled maneuverability of mold 40 during forming and baking sequences, if so desired. Clearly, there are numerous alternative handling means that would accomplish the same purpose, as would be known to those in the trade.

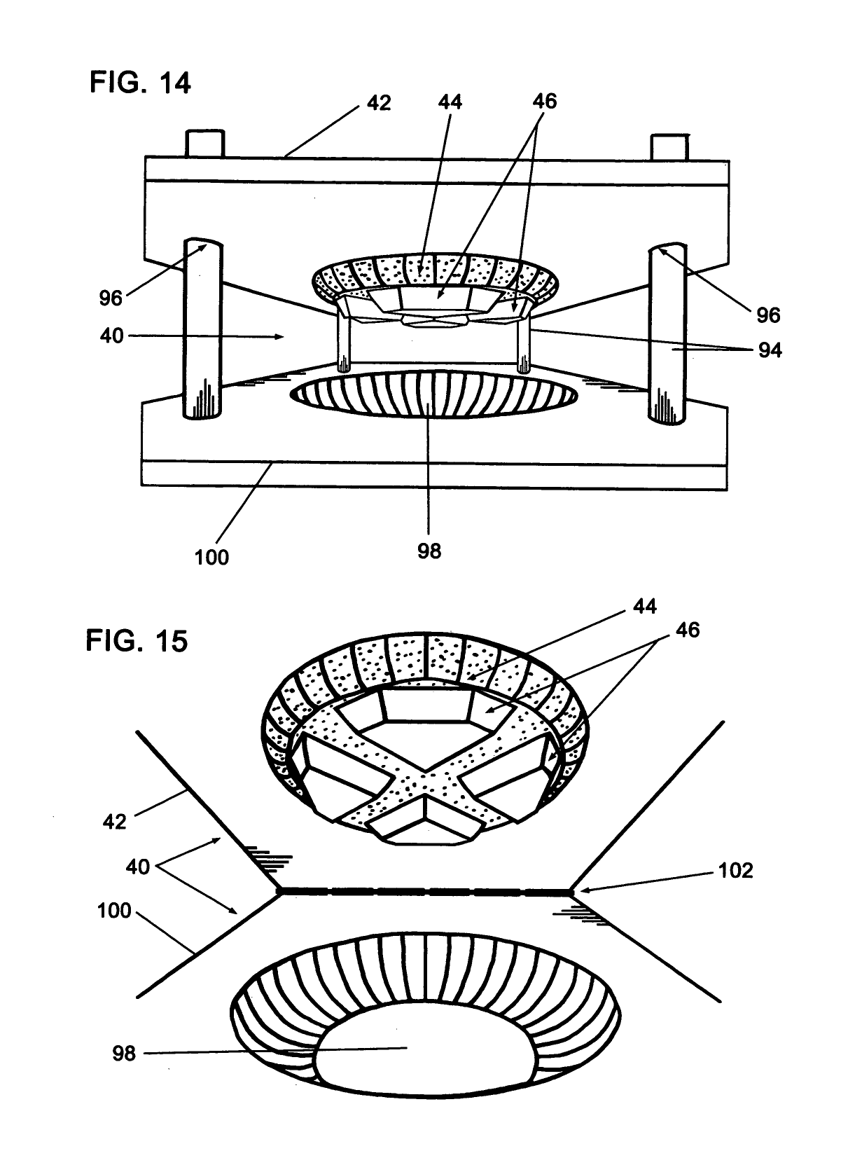

FIG. 14 illustrates yet another variation on the most basic mold embodiment of FIG. 10B, this time with the addition of an opposing, compatibly-shaped well 98 or depression mold into which the multi-level cavity shaping means would be pressed, thus displacing and forming the pre-determined amount of sandwich-forming compound that was initially placed into this opposing, depression mold. The purpose of this compatible depression mold is to help shape the exterior bun profile with a more precise perimeter margin on the bun's sides and bottom. Although not necessary, FIG. 14 also depicts use of an alignment means between mold 40's rigid material 42 and opposing well 98's rigid material 100, in this case with vertical guide rods 94 and corresponding guide shafts 96, to insure more consistent and accurate mold interfacing.

FIG. 15 illustrates an alternative alignment means between rigid materials 42 and 100, namely hinge 102, similar to what is commonly used on waffle-iron type appliances. Clearly, there are numerous other alternative alignment means known to the trade that would function adequately here.

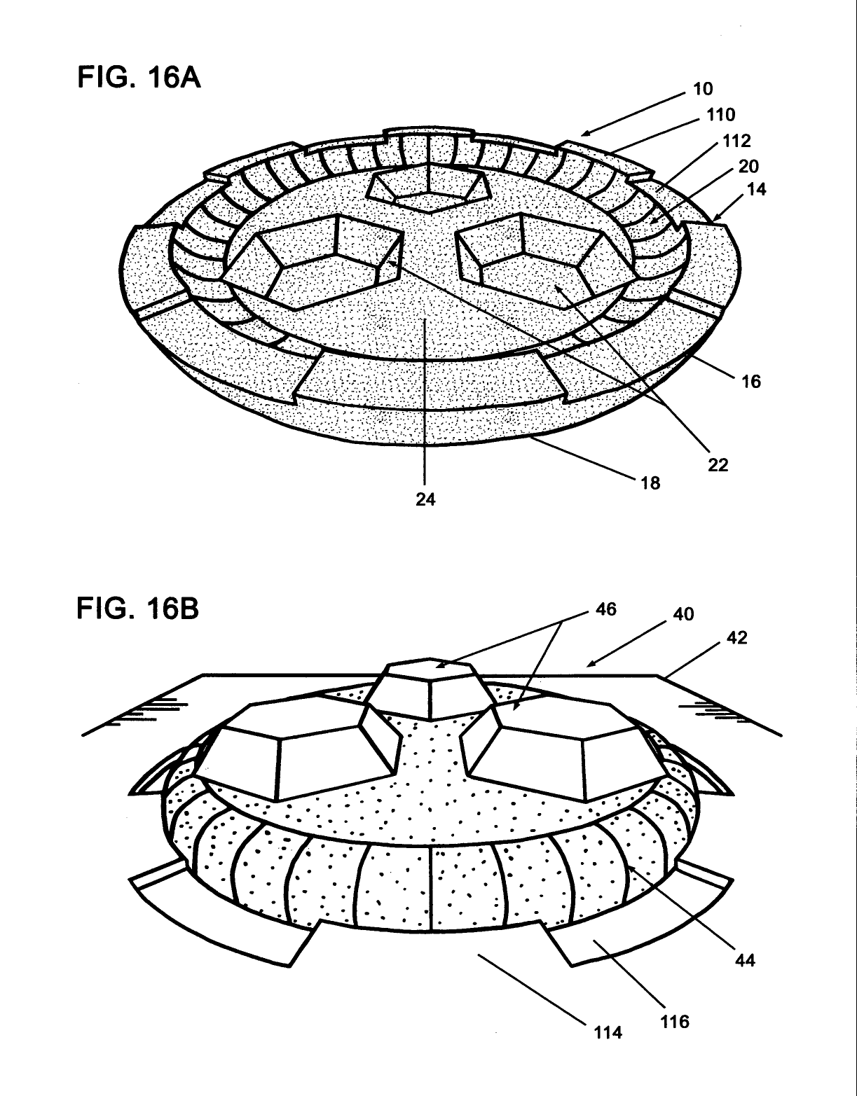

FIGS. 16A and B show another bun/mold variation of the most basic bun/mold embodiment of FIGS. 10A and B, this time featuring the extra element of an interlocking means between bun base 10 and bun lid 12 (not shown). This recognizes that, in some instances, it may be advantageous to create an upper and lower bun combination that not only achieves total enclosure of the sandwich components (i.e. both primary and secondary), but also a way to “interlock” their opposing perimeter rims 14 so as to further inhibit any potential lateral shifting of bun halves, particularly with primary sandwich components of a less solid nature like egg salad, tabouli etc. Bun base 10 in FIG. 16A features “castle-stepped” perimeter rim 14 with alternating rim step-up segments 110 and rim step-down segments 112. Clearly, an identical copy of this bun base 10 if inverted and slightly rotated, would effectively “interlock”, thus inhibiting any lateral shifting. FIG. 16B shows the corresponding mold to achieve this “castle-stepped” rim with alternating mold rim step-up 114 and mold rim step-down 116 segments within rigid material 42.

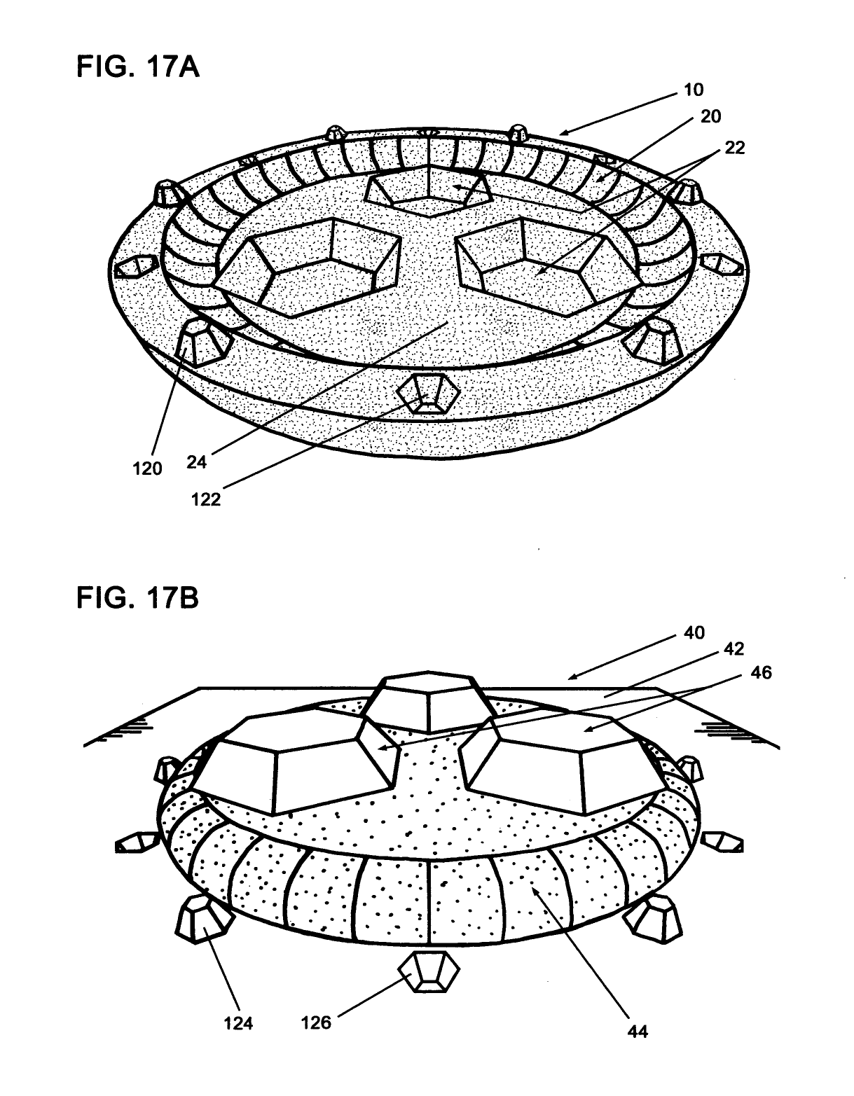

A different example of bun/mold interlocking means is depicted in FIGS. 17A and B, respectively. Bun base 10 in FIG. 17A shows alternating perimeter rim 14 nubs 120 and corresponding holes 122 of a truncated hexagonal pyramid profile. FIG. 17B illustrates the corresponding mold necessary to achieve this rim configuration, with mold 40 having reciprocal nubs 124 and holes 126 in rigid material 42. There are obviously numerous other configurations to achieve a similar effect of interlocking means between bun halves.

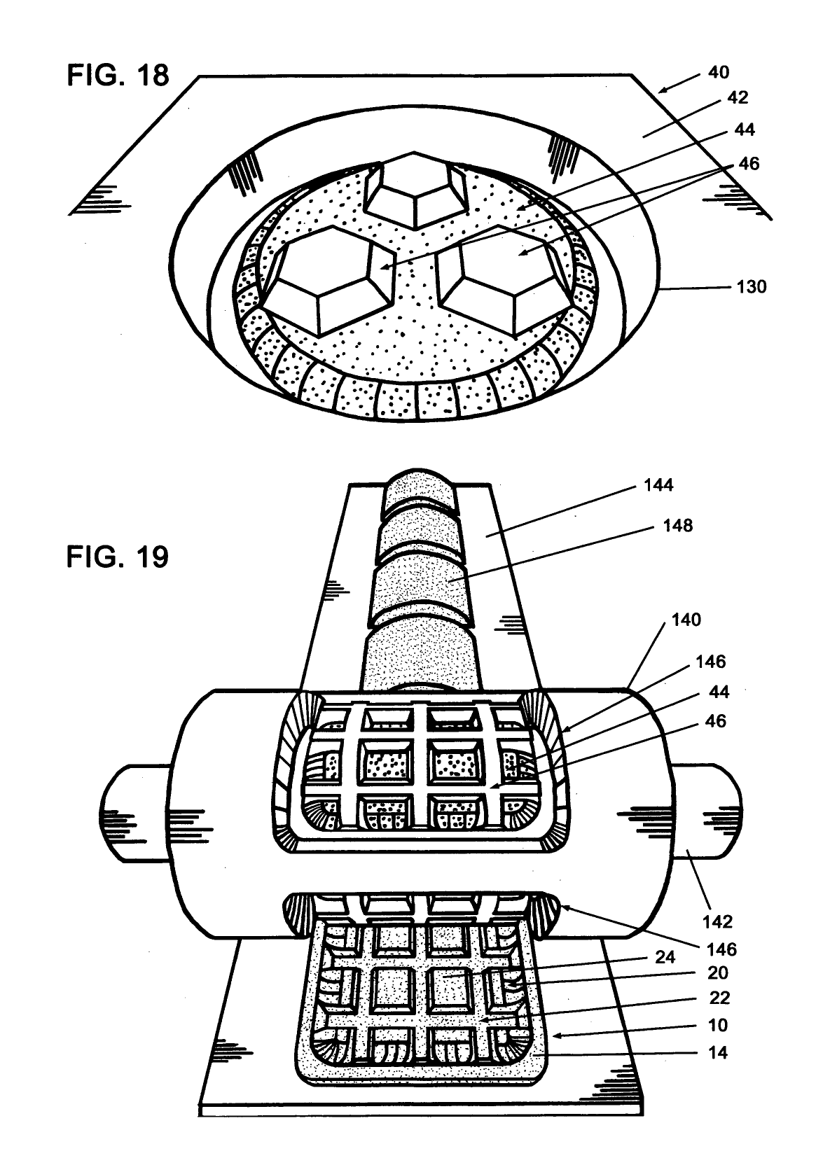

As alluded to earlier and depicted in FIG. 11, a containment wall 58 around the multi-level cavity shaping means helps shape a more consistent margin in the perimeter rim 14 and wall 16 particularly for sandwich-forming compounds of a more liquid/lower viscosity level. FIG. 18 shows a submerged well alternative configuration to this mold embodiment, in this case, with both well wall 130 and the first and second level cavity-shaping means 44 and 46, respectively, submerged below the surface plane of rigid material 42. A plurality of this submerged well mold configuration could be repeated onto a larger baking sheet, for batch production of these duplex-cavitied contoured buns.

In order to achieve mass production efficiencies, it is also possible to adapt the preferred mold embodiment of this invention into a more automated rolling pin configuration. FIG. 19 illustrates an example of such an application, with a plurality of mold 40, in this case, the mold for rendering square buns with square burger-type first level cavities (as shown in FIG. 7B) arrayed and submerged into the surface of suitably-sized, cylindrically-shaped rolling pin 140. In this type of configuration, as pin 140 is pressure-rolled onto a production line of pre-determined and appropriately spaced dough quantities 148, a theoretically never-ending line of duplex-cavitied buns 10 can be shaped, proofed and subsequently baked with mass-production efficiencies, as would be readily appreciated and understood by those in the trade.

Although this specification has discussed a wide variety of alternative embodiments to the present invention, clearly there is an infinite number of reasonable further permutations and combinations of this unique multi-level cavitied contoured bun concept that should be included within the scope of this invention. Furthermore, it is the intent of this invention to include not only physical molds but also “virtual” molds of this multi-level cavitied bun. As those in the molding trade fully understand, for every mold there is a corresponding computer assisted design (CAD) “virtual” representation of the same mold. It is technically feasible to produce a multi-level cavitied bun without using a physical or utility mold. For example, the existing technique of stereolithography (SLA) could be modified to literally print an actual bun layer-by-layer using a suitable consistency of sandwich-forming compound instead of plastic resin, following a pre-determined “virtual” mold. Beyond this, a multi-level cavitied bun could be realized through CAD-guided selective laser sintering (SLS) literally from a starter block of non-contoured bread, again without using a physical mold. Therefore, it is reasonable that the scope of this invention include “virtual” as well as physical representations of this broad multi-level cavitied bun concept.

1. For shaping superior contoured bases and lids for sandwiches and the like, a mold comprising:
a substantially rigid sheet material
a multi-level cavity shaping means integral to said sheet material for shaping the interior surface of said bases and lids by creating a first level major cavity and at least a second level plurality of well-distributed minor cavities extending vertically beyond said first level cavity, the bottom of said multi-level cavity shaping means and said sheet material being co-planar, the shape and size of said first level major cavity being compatible with the anticipated profile of a primary sandwich component, the shape and total volume of said second level plurality of minor cavities being compatible with the shape and combined mass of one or more anticipated secondary sandwich components,
whereby once a suitable sandwich-forming compound has been applied to said mold and sequenced through proofing, drying and/or baking and removal from said mold, the resulting sandwich base or lid reflects an optional exterior appearance with a largely uninterrupted perimeter rim, exterior wall and bottom, while the novel, hallowed interior features a first level major cavity under which is a second level plurality of minor cavities,
thus allowing said one or more secondary sandwich components to be strategically placed into said second level minor cavities and said primary sandwich component into said first level cavity, such that the secondary sandwich components are separate from but immediately adjacent to the primary sandwich ingredient,
thus recognizing that said first level major cavity will effectively cradle said primary sandwich ingredient, largely preventing any significant lateral movement, while the portion of said sandwich-forming compound between said second level cavities will become structural support for said primary sandwich component in said first level cavity, thereby largely preventing any significant sandwich compression during consumption, which would otherwise lead to pressured migration of said secondary sandwich components from said second level cavities into said first level cavity and potentially to the undesirable messy leakage or spillage beyond the interior region of said sandwich base or lid.

2. The mold of claim 1, wherein said multi-level cavity shaping means comprising:
a first level major cavity shaping means for creating a contoured depression into the interior surface of said sandwich base or lid, said first level major cavity shaping means being compatibly shaped to the perimeter bottom or top profile of an anticipated primary sandwich component in horizontal alignment, the bottom plane of said first level major cavity shaping means being co-planar with said substantially rigid sheet material,
a second level plurality of minor cavity shaping means, integral to said first level cavity shaping means, the bottom of said second level plurality of minor cavity shaping means co-planar with the top of said first level major cavity shaping means, the overall dimension of said integrated first and second level cavity shaping means being marginally smaller than the desired completed sandwich base or lid dimensions,
whereby once a suitable sandwich-forming compound has been applied to said mold and sequenced through proofing, drying and/or baking and removal from said mold, the resulting sandwich base or lid broadly reflects a largely traditional exterior appearance with an uninterrupted perimeter rim, exterior wall and bottom, while the novel, hallowed interior features a first level major cavity under which is a second level plurality of minor cavities,
thus allowing one or more secondary sandwich components to be strategically placed into said second level minor cavities and a primary sandwich component into said first level cavity, such that the secondary sandwich components are separate from but immediately adjacent to the primary sandwich ingredient,
thus recognizing that said first level major cavity will effectively cradle said primary sandwich ingredient, largely preventing any significant lateral movement, while the portion of said sandwich-forming compound between said second level cavities will become structural support for said primary sandwich component in said first level cavity, thereby largely preventing any significant sandwich compression during consumption, which would otherwise lead to pressured migration of said secondary sandwich components from said second level cavities into said first level cavity and potentially to the undesirable messy leakage or spillage beyond the interior region of said sandwich base or lid.

3. The mold of claim 2, wherein said mold further comprising:
a perimeter gutter set into said sheet material around the bottom of said first level major cavity shaping means to help define and shape the perimeter rim of said sandwich base or lid,
whereby said mold can effectively accommodate said sandwich-forming compounds of a high-viscosity consistency.

4. The mold of claim 2, wherein said mold further comprising:
a perimeter wall marginally spaced around said first level major cavity shaping means, the bottom of said perimeter wall being co-planar with the bottom of said first level major cavity shaping means, the top of said perimeter wall being marginally higher than the height of said first level major cavity shaping means, the differential in height determining the thickness of said sandwich base, not accounting for expansion or shrinking of said sandwich-forming compound during proofing, drying and/or baking,
whereby said mold can effectively accommodate said sandwich-forming compound of not only a high-viscosity consistency but alternatively of a more liquid/lower viscosity consistency, contained by said perimeter wall.

5. The mold of claim 2, wherein said mold further comprising:
a second substantially rigid sheet material
a depression in said second sheet material that defines the exterior shape of said sandwich base or lid, said depression being marginally deeper and wider than said first and second level cavity shaping means,
whereby, when a pre-determined volume of sandwich-forming compound is placed within said depression and fully displaced by said mold, the compound substantially fills the void between said depression and said mold.

6. The mold of claim 2, wherein said mold further comprising:
a handle means attached to the bottom of said mold for ease of manual placement and removal of said mold.

7. The mold of claim 2, wherein said mold further comprising:
an interlocking molding means integrated into said substantially rigid material in the marginal area around the base of said first level major cavity shaping means,
whereby when two completed sandwich bases or a completed base and lid are interfaced, their perimeter rims are complimentary and substantially laterally immobilized.

8. The mold of claim 4, wherein:
said perimeter wall and said first and second level cavity shaping means are positioned above said sheet material such that the bottom of said perimeter wall and said first level major cavity shaping means are aligned horizontally with said sheet material.

9. The mold of claim 4, wherein:
said perimeter wall and said first level major cavity shaping means are positioned below the plane of said sheet material such that the top of said perimeter wall is aligned horizontally with said sheet material.

10. The mold of claim 4, wherein:
a plurality of said molds are radially arrayed and integrated into the exterior surface of a suitably-sized rigid cylindrical member,
whereby when said cylindrical member is manually or mechanically pressure rolled onto a bed of said sandwich-forming compound of uniform, pre-determined thickness, the revolving molds efficiently produce a continuous stream of contoured sandwich bases or lids ready for proofing, drying and/or baking sequence.

11. The mold of claim 5, wherein:
said mold and said depression having an alignment interfacing means for consistent alignment during press and release of said mold from said depression,
a locking means between said two sheet materials,
whereby properly aligned mold pressure can be maintained throughout the proofing, drying and/or baking sequence.

12. The mold of claim 11, wherein said mold further comprising:
a waffle iron housing
one or more pairs of said mold and said depression incorporated into the upper and lower sections of said waffle iron housing,
a heating means for applying a controlled even heat to the upper and lower sections of said waffle iron housing,
whereby when a pre-determined amount of said sandwich-forming compound is placed into said depression, displaced by said upper housing mold after said alignment and locking means, and then baked and released, contoured multi-level cavitied sandwich bases and/or lids will result.

13. The mold of claim 2, wherein said mold further comprising:
mold release coating means applied to the interior surfaces of said mold for reducing the friction between said sandwich-forming compound and said mold,
whereby completed or partially completed sandwich bases or lids can be removed from said mold more easily with reduced sticking.

14. The mold of claim 2, wherein said mold further comprising:
a plurality of vent holes strategically positioned from the inside to the outside defining surfaces of said mold,
whereby when sandwich-forming compound is applied to said mold, any potentially trapped air may escape more readily.

15. The mold of claim 14, wherein said mold further comprising:
an air channeling means for directing air flow through said plurality of vent holes,
whereby vacuum pressure can be applied to more efficiently distribute said sandwich-forming compound throughout said mold or blowing pressure can be applied to facilitate release of said sandwich base or lid from said mold.

16. The mold of claim 2, wherein said second level plurality of cavity shaping means comprising:
a network of largely evenly spaced intersecting, truncated walls,
whereby the mold renders a waffle-like grid of bread support columns in said second level to support said primary sandwich component.

17. The mold of claim 16, wherein:
said second level cavity shaping network of intersecting walls are largely perpendicular,
whereby the resulting bread support columns within the second level are truncated square pyramids.

18. The mold of claim 16, wherein:
said second level cavity shaping network comprises a plurality of concentric walls and radial walls outwards from the center of said mold,
whereby the resulting bread support columns within the second level are truncated, concentric circle segments.

19. For shaping superior contoured bases and lids for sandwiches and the like, a virtual CAD representation of bun comprising:
a largely uninterrupted perimeter rim, exterior wall and bottom surface
a hallowed, interior surface featuring a first level major cavity and a second level plurality of minor cavities,
whereby a multi-level cavitied sandwich base or lid can be realized through layer-by-layer sintering/baking of sandwich-forming compound, by laser contour cutting from a solid, non-contoured sandwich base or lid, or from other such CAD-guided method.
